(19) United States
(12) Patent Application Publication
(10) Pub. No.: US 2026/0065137 A1
(43) Pub. Date: Mar. 5, 2026

(54) SYSTEMS AND METHODS FOR COMPRESSING MODELS DURING MODEL TRAINING WHILE CONSIDERING TARGET ALIGNMENT FOR EFFICIENT AI RUNTIME

(71) Applicant: NetApp, Inc., San Jose, CA (US)

(72) Inventor: Anton Krug, Carlow (IE)

(21) Appl. No.: 18/823,829

(22) Filed: Sep. 4, 2024

(51) Int. Cl. G06N 20/00

(52) U.S. Cl. CPC G06N 20/00

(57) ABSTRACT

Techniques are provided for compressing weights of models during training of the models. A model is trained for execution on a target device. As part of training, weights of the model are compressed utilizing palettes to represent weight values using bits. A coding procedure, such as Huffman coding, is used to remove or modify the bit representations of infrequently utilized palettes. The model may be iteratively trained to compress the weights of the model in order to reduce the amount of storage consumed by the model without unduly sacrificing quality of the model. Reducing the size of the model provides the ability to deploy the model on devices that would otherwise lack storage and compute resources for storing and running an uncompressed version of the model.

### TECHNICAL FIELD

Various embodiments of the present technology relate to compressing weights of models during training of the models.

### BACKGROUND

Many devices utilize models, such as artificial intelligence (AI) and machine learning (ML) models, for implementing various types of functionality. For example, a mobile device may utilize a model to perform predictive text input to suggest words to a user as input into a user interface of the mobile device. A search engine may utilize a model to predict what images, websites, and/or other content may be of interest to a user. Often, a model is hosted at a server that has adequate compute and storage resources for running the model. Thus, client devices must connect to the server over a network in order to leverage functionality provided by the model. Many devices may lack resources such as storage, runtime memory, and runtime compute resources required to store and run models such as AI inference models. Thus, these devices cannot leverage the functionality provided by these models unless the devices can remotely access a server or service hosting the models, which can result in unacceptable delay due to the devices communicating with the server or service over a network connection. This also results in additional costs such as mobile data usage costs, and performance issues if there is insufficient network infrastructure for the device to remotely access a service hosting a model. These devices must also be online and connected to the service in order to access functionality provided by the model, and thus cannot support an offline mode.

### DESCRIPTION OF THE DRAWINGS

Embodiments of the present technology will be described and explained through the use of the accompanying drawings in which:

FIG. 1 is a block diagram illustrating an embodiment of a system for compressing a model during training of the model, in accordance with an embodiment of the present technology.

FIG. 2 is a flow chart illustrating an embodiment of a method for compressing a model during training of the model, in accordance with various embodiments of the present technology.

FIG. 3 is a block diagram illustrating an embodiment of a system for compressing a model during training of the model, in accordance with an embodiment of the present technology.

FIG. 4 is a block diagram illustrating an embodiment of a system for compressing a model during iterative training of the model, in accordance with an embodiment of the present technology.

FIG. 5A is an illustration of a data structure used as part of compressing a model during training of the model, in accordance with an embodiment of the present technology.

FIG. 5B is an illustration of a data structure used as part of compressing a model during training of the model, in accordance with an embodiment of the present technology.

FIG. 5C is an illustration of a data structure used as part of compressing a model during training of the model, in accordance with an embodiment of the present technology.

FIG. 5D is an illustration of a data structure used as part of compressing a model during training of the model, in accordance with an embodiment of the present technology.

FIG. 5E is an illustration of a data structure used as part of compressing a model during training of the model, in accordance with an embodiment of the present technology.

FIG. 6A is a block diagram illustrating an embodiment of a system for utilizing a compressed model to generate an output, in accordance with an embodiment of the present technology.

FIG. 6B is a block diagram illustrating an embodiment of a system for utilizing a compressed model to generate an output, in accordance with an embodiment of the present technology.

FIG. 7 is an illustration of a data structure used as part of compressing a model during training of the model, in accordance with an embodiment of the present technology.

FIG. 8 is a block diagram illustrating an example of a node in accordance with various embodiments of the present technology.

FIG. 9 is an example of a computer readable medium in accordance with various embodiments of the present technology.

The drawings have not necessarily been drawn to scale. Similarly, some components and/or operations may be separated into different blocks or combined into a single block for the purposes of discussion of some embodiments of the present technology. Moreover, while the present technology is amenable to various modifications and alternative forms, specific embodiments have been shown by way of example in the drawings and are described in detail below. The intention, however, is not to limit the present technology to the particular embodiments described. On the contrary, the present technology is intended to cover all modifications, equivalents, and alternatives falling within the scope of the present technology as defined by the appended claims.

### DETAILED DESCRIPTION

Various embodiments of the present technology relate to compressing weights of models such as artificial intelligence / machine learning (AI/ML) models. Many models such as AI inference models have demanding storage, runtime memory, and runtime compute resource requirements. A model may require expensive, power hungry hardware, and/or hardware that cannot practically fit within a mobile device or a single node of a cluster. Additionally, a significant amount of storage is needed in order to store a model with a large number of weights (parameters). Thus, many models require resources that are beyond the capabilities of certain devices, such as on-prem computers, low-end and low-powered devices such as reduced instruction set computer (RISC) devices and field programmable gate array (FPGA) devices, and/or consumer devices such as laptops. Many devices are unable to run such models because the devices do not have adequate hardware and power resources for storing and running the models. For example, some models may have billions of weights (parameters) that can consume a significant amount of storage, and many devices do not have adequate runtime memory for storing such weights during runtime of a model. The weights of the model may be stored into memory because it is not practical to access a hard disk drive or network storage each time a weight is used, and thus memory of a device is a significant constraint on whether a device can run a model.

These devices cannot leverage functionality provided by the models unless the devices access remote servers and services over a network, which can introduce unacceptable delay due to network communication time. For example, a mobile device may be unable to provide timely voice to text functionality in real-time as a user is talking into the mobile device due to network latency associated with the mobile device assessing a remote voice to text service over a cellular connection.

Conventional compression techniques may compress a model post-training after the model has been trained. Post-training compression may heavily quantize models in order to compress the models. Quantization is where the number of bits needed to represent information within a model is loosely reduced, which reduces the size of the model (e.g., converting model weights from large floating point numbers to single bit representation or anything in-between). However, compressing a model after training can greatly reduce the quality of the model because information related to how compression affects the quality of output from the model cannot be tracked and used to iteratively adjust the compression during iterative cycles of training. In particular, perplexity of a model relates to how much confidence the model has in an output (e.g., perplexity relating to a confidence of a token such as one or more letters, a word, or subset of a word). Perplexity (e.g., confusion of the model) is one indicator of the quality of the model. Post-training compression increases the perplexity of the model, thus diminishing the quality of the model that will now have lower confidence and generate incorrect outputs (e.g., an inference that an image depicts a cat, but the image does not actually depict a cat).

The disclosed techniques overcome these disadvantages of conventional compression techniques by compressing a model during training of the model, such as where the model is quantized during training. By compressing the model during training of the model, the compression of weights can be iteratively adjusted during training cycles based upon the effect that the compression has on the quality of the model (e.g., if a certain amount of compression affects the quality of the model too much, then the compression can be reduced or modified during a subsequent training cycle). Dynamically adjusting how weights are compressed during iterative cycles of training the model produces a compressed model that has lower perplexity, higher confidence, and overall more correct outputs than if the model was compressed after training. In particular, palettes and/or a coding procedure is used to compress weights of a model while the model is being trained. The palettes are used to represent weight values using bits that consume less storage than the actual weight values (e.g., a weight may be represented by a certain range of values, such as a range 3 values, a range of 5 values, etc.). The coding procedure is used to identify, remove, or modify the bit representation of infrequently used palettes for improved compression of the model.

Compressing the weights of the model during training of the model produces a compressed model that produces higher quality outputs with lower perplexity compared to models that are compressed after training. This provides the ability to compress the model down to sizes that will allow the model to be run on devices that otherwise would not have the resources to run an uncompressed version of the model. The model is compressed (e.g., dynamically compressed with iterative adjustments during each training cycle) without unduly affecting quality of the model (e.g., without quantizing/decimating the model so much that outputs from the model are inaccurate and have low confidence with high perplexity).

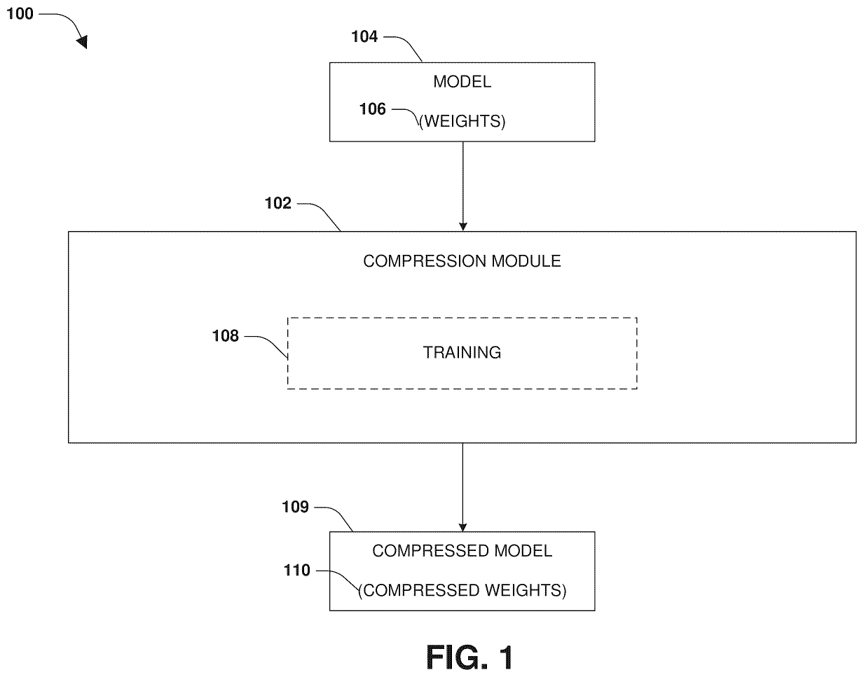

FIG. 1 is a block diagram illustrating an embodiment of a system 100 for compressing a model 104 during training 108 of the model 104. A compression module 102 may be implemented to compress weights 106 of the model 104 while the model 104 is being trained 108 to generate outputs (e.g., trained to generate outputs based upon labeled input training data such as to generate tokens of one or more letters such as a word or a subset of a word). The model 104 may include a large number of weights 106 such as billions of weights, which may make the model 104 impractical or impossible to run on certain devices such as consumer devices, Internet of Things (IoT) devices, etc. Accordingly, the compression module 102 compresses the weights 106 of the model 104 during training 108 of the model in order to create a compressed model 109 with compressed weights 110. In some embodiments, the compression module 102 creates the compressed model 109 to comprise both compressed weights and uncompressed weights.

The compression module 102 may quantize (compress) the model 104 by constraining weight values to a range of values, which consumes less storage than using large floating point numbers as weight values. By performing the quantization during training 108 of the model 104 to create compressed weights 110, there is a minimal effect on the quality of the compressed model 109 because the quantization can be iteratively adjusted during training cycles based upon how current quantization affects a quality of the compressed model 109.

In some embodiments, the compressed weights 110 of the compressed model 109 may be used for matrix multiplication. In general, matrix multiplication is a resource intensive operation used by models that output AI inferences. By using merely a few values, the compressed model 109 can be stored and run by various types of devices (e.g., consumer devices, IoT devices, etc.) that otherwise would not have resources to run the uncompressed model 104. Even if palette compression is performed upon larger floating point numbers (compared to a range of a few values), performance can be improved to reduce the impact from multiplication. Such devices are capable of running the compressed model 109 to output AI inferences because merely addition and/or subtraction are needed to effectively produce matrix multiplication results.

Heavily quantized models have many benefits such as increased performance, less resource consumption for execution, and/or less storage resource consumption. The constrained weights may be further shrunk by using palette indexing of these values. Additionally, the palette may be shrunk using various techniques such that surrounding weights can compensate for errors that occur during the training due to the additional compression. Low-level details of a target device to which the compressed model 109 will be deployed (e.g., available resources such as runtime compute, runtime memory, storage, etc.) may be used to create/modify the compressed model 109 (e.g., modify a model configuration such as weights, parameters, etc.) so that the compressed model 109 and/or the target device may perform optimally together.

In some embodiments, palette usage statistics are obtained such as during the training 108 of the model 104. The palette usage statistics are used to apply a coding procedure such as Huffman coding to shrink the weights 106 (the compressed weights 110) even further such as through palette shrinking. If palette shrinking would not be successful in removing some palette entries without affecting the quality of the compressed model 109 too much, then the use of those palette entries is discouraged (e.g., used less frequently), which can be enough for Huffman coding to provide a benefit for compressing the model 104.

In some embodiments, the weights may utilize more values (5 values, such as across a range of −2 to +2) so that model trainers have more options (e.g., more possible weight values) for training a higher quality model. In some embodiments, certain weights may retained as uncompressed weights, some weights may be constrained to 3 values, other weights may be constrained to 5 values, etc. The compression can be applied to the 3 value bit range and/or the 5 value bit range (e.g., compression using palettes and/or Huffman coding). In some embodiments, CPU and FPGA implementations of the model 104 can use 5 value bit range weights without needing to execute a resource intensive multiplication operation to efficiently do matrix multiplication because 2's complement bit shifting is fast and can be applied instead of multiplication by 2. CPU architectures such as RISC-V, Arm-based CPUs, and/or other types of CPUs may have instructions that can do shifting at the same time as addition/subtraction. So, in some embodiments, the larger range of weight values (e.g., the 5 value bit range) does not significantly affect the CPU performance despite producing more work.

In some embodiments, code of the compressed model 109 is optimized for a particular CPU of the target device for improved efficiency and/or so that the compressed model 109 can provide AI functionality for low-end and low-powered device. In some embodiments, the code may be designed for RISC devices in order to greatly improve performance. Each instruction of the code that can be skipped/removed has a compounding impact when repeated a large number of times such as a billion times. In some embodiments, the logic of the compressed model 109 implemented by an FPGA may be tailored so that matrix multiplication can be performed without having to execute an actual multiplication operation. When the target device (e.g., a CISC CPU or FPGA) is configured to be fully optimized for a particular model such as the compressed model 109 and is restricted from running any other types of models, then the target device can perform AI inferencing with the specific model much more optimally.

In some embodiments where the target device is a CPU, run-time problems can be treated and addressee as compile-time problems and solutions. That is, many lookup tables of the compressed model 109 can be grouped into a single lookup table so that there is merely 1 level of indirection. Even the single lookup table can be simplified away, and thus a lookup may be skipped in the typical sense. In an example, some linker-script functionality may be implemented in order to skip the lookup, such as by equally spacing functions (e.g., optionally using padding where necessary for equal spacing), a pointer to these functions can be easily computed without having to do the lookup. In an example, various modifications are made to the compressed model 109 to remove certain instructions, memory accesses, and/or branching. Reducing branching will make a branch predictor of the CPU very efficient. Sometimes doing more work with predictable code that has less branching will outperform less work with unpredictable code that has more branching. When the target device is optimized for a specific model, a lot of pre-compiled functions can be omitted because the functions that will be utilized and the functions that will not be utilized can be identified such as during iterative training cycles of the training 108. In some embodiments, the code can be optimized by a toolchain, which makes some code efficient and small. In some embodiments where the target device is an FPGA that is configured with a non-generic inference engine as opposed to a generic inference engine, hard-wired lookup tables can be used to omit multiple steps that would otherwise by performed by the generic inference engine, and thus the non-generic inference engine is configured to more efficiently run the compressed model 109 using less steps/instructions.

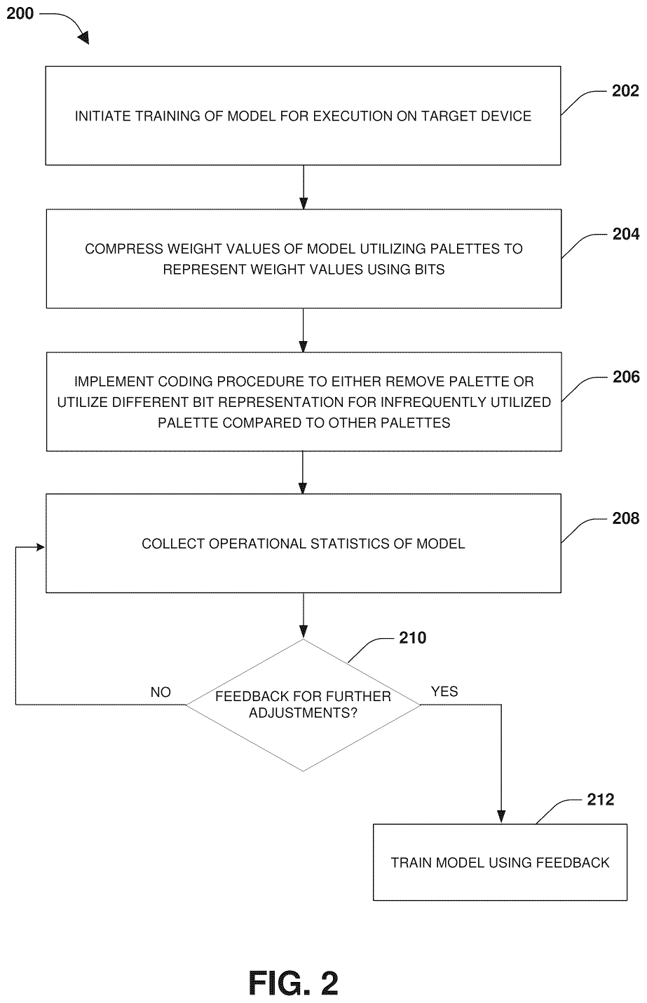

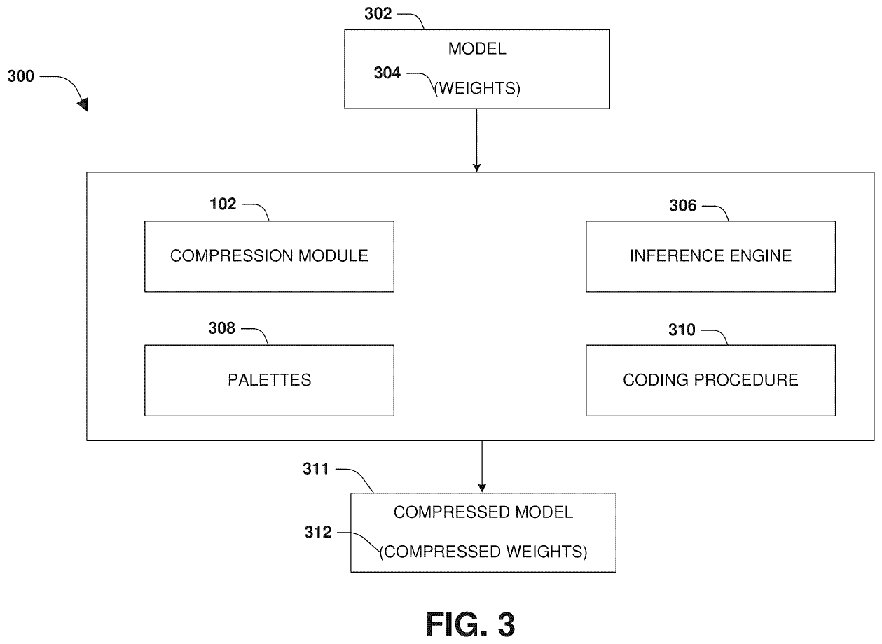

FIG. 2 is a flow chart illustrating an embodiment of a method 200 for compressing a model 302 during training of the model 302, which is described in conjunction with system 300 of FIG. 3. During operation 202 of method 200, the compression module 102 initiates training of the model 302 for execution upon a target device. The compression module 102 may be configured to compress weights 304 of the model 302 to create compressed weights 312 of a compressed model 311. The resulting compressed model 311 may include the compressed weights 312 or a mixture of both the compressed weights 312 and uncompressed weights that can be used for generating inference results.

During operation 204 of method 200, the compression module 102 compresses, during the training of the model 302, the weights 304 utilizing palettes 308 to represent weight values using bits. In some embodiments of compressing the weights 304, the weights 304 are constrained to a set of values such as a range of 3 values (e.g., 1, 0, +1), a range of 5 values (e.g., −2, −1, 0, +1, +2), or any other set of values. In some embodiments where the weights 304 are constrained to 5 values, bit shifting may be implemented, in place of executing an actual multiplication operation, to perform matrix multiplication in a more efficient manner. In some embodiments, the weights 304 are stored as byte-aligned data such as where 5 weight values are stored within a single byte (e.g., around 1.6 bits are used to represent a weight, and thus 5 weights can be stored within an 8 bit number). In some embodiments, the compression includes adjusting a weight value of a weight that occurs less frequently than other weight values of the weight. Other weights (neighboring weights) compensate for the adjusted weight during the training. For example, if a weight has values 0, 0, −1, 1, and 1, then the −1 may be iteratively adjusted to either 0 to 1 so that the weight has merely 2 potential states instead of 3, thus compressing the weight.

During operation 206 of method 200, a coding procedure 310 such as Huffman coding, is implemented for palettes that are identified during the training as infrequently utilized palettes. The coding procedure 310 either removes an infrequently utilized palette or utilizes a different bit representation for the infrequently utilized palette (a longer bit representation) compared to other more frequently utilized palettes. That is, when the model 302 is being trained, the model 302 may utilize certain weights, represented by certain palettes, more than other weights represented by other palettes when generating outputs. This palette usage is tracked and used to identify infrequently utilized palettes that can be removed or represented differently for improving or further compressing the model 302. In some embodiments, in response to identifying a frequently utilized palette that is utilized more than other palettes, the coding procedure is implemented to utilize a shorter bit representation for the frequently utilized palette than other palettes for improving or further compressing the model 302.

In some embodiments, the training of the model 302 includes shifting weights/parameters of the model 302 in order to reach a global minima. During the training, randomized noise and/or errors may be introduced to shift/nudge the model 302 away from a local minima towards the global minima. In this way, the model 302 is trained to output higher quality outputs such as more correct outputs (e.g., a language-based model used to generate tokens as outputs) having high confidence and less perplexity.

During operation 208 of method 200, operational statistics are tracked during iterative training of the compressed model 311 such as the quality of the compressed model 311 (e.g., tracking precision, recall, a percentage of output that are correct or incorrect, an amount of time to generate an output, memory utilization, compute resource utilization, storage utilization, etc.). The operational statistics may be used as feedback for further training the compressed model 311. During operation 210 of method 200, a determination is made as to whether the operational statistics should be used as feedback for further adjusting the compressed model 311 (e.g., a quality of the compressed model 311 may still be high enough that further compression could be performed; the quality of the compressed model 311 may be unacceptable and thus the compressed model 311 is to be less quantized; etc.). If the operational statistics do not indicate that the compressed model 311 is to be adjusted, then operation of the compressed model 311 may be further monitored for feedback.

If the operational statistics indicate that the compressed model 311 is to be adjusted, then the compressed model 311 is further trained using the feedback, during operation 212 of method 200. In some embodiments, palette shrinking may be performed by the coding procedure 310 to remove palette entries in order to compress the compressed model 311. If removal of a palette entry as part of palette shrinking affects quality of the compressed model 311 beyond an acceptable amount (e.g., a percentage of incorrect outputs is greater than a threshold percentage), then a weight is modified based upon the feedback to discourage utilize of the weight by the compressed model 311 (e.g., the weight may be associated with the palette entry that may be added back into the compressed model 311, and the weight is modified instead of removing the palette entry). In some embodiments, the compressed model 311 is further compressed if the feedback indicates that the quality of outputs (correctness) is above an acceptable amount.

In some embodiments, the weights 304 are quantized and compressed during the training. New errors generated from the quantization and compression are identified from the operational statistics (e.g., incorrect outputs from the compressed model 311 after training). The weights may be adjusted during subsequent training based upon the new errors in order to reduce errors of the compressed model 311. Quantization of the weights during training may be used to adjust the compressed model 311. In some embodiments of adjust weights, a first error produced by rounding a weight value to a first whole number is identified. A second error produced by rounding the weight value to a second whole number is identified. The weight value is rounded towards whichever whole number resulted in the smaller error. In some embodiments, if a weight of 0.57 is merely quantized after training to round up or down such as to 1, then the quality of the weight may be low compared to if the weight was actually rounded to 0. Because the conventional quantization is performed post-training, there is no training feedback loop that can be used as insight for how best to quantize or round the weight (e.g., post-training quantization does rounding blindly with no context/information). The disclosed techniques can perform the quantization during training where feedback can be used to determine that rounding the weight to 0 will produce a higher quality result/output from the compressed model 311 than if the weight was rounded up to 1. Because the compressed model 311 is being iteratively trained using feedback, the rounding up and down of weights can take into account the feedback, and can be confirmed by running the compressed model 311 to check the results (e.g., run the compressed model 311 with the weight rounded down to 0 and also run the compressed model 311 with the weight rounded up to 1 to see which gives the smallest error). Other weights may be flipped from 0 to 1 (if the weight is rounded down to 0) in order to compensate for the error introduced by rounding down to 0, thus producing an output closer to unquantized results.

In some embodiments, weights are ordered during training to create an ordered set of weights. Weights may be swapped between positions as part of ordering the weights. That is, when weights are compressed using the palettes, some ordering may be applied to the weights (instead of merely compressing the weights), and thus the position of some weights may be swapped. In particular, the position of weights may be modified (e.g., nudging specific positions of weights) to have only certain values. For example, a first weight and every 4^{th} weight thereafter are constrained to two values such as 0 and 1. A second weight and every 4^{th} weight thereafter are constrained to two values such as −1 and 0. This means that the positions are compressed enough to have a role of “negator” or “adder. ” Instead of the original weights being forced into these roles, the weights can be shuffled and swapped instead. For example, the position of weight values matters for image data where a red dot in the middle of the screen compared to a left side of the screen makes a difference. But in networks where everything is connected with everything else (e.g., nodes are connected to each other), the order of weights and/or nodes can be changed with little to no impact on an output, thus making the compression of the weights easier.

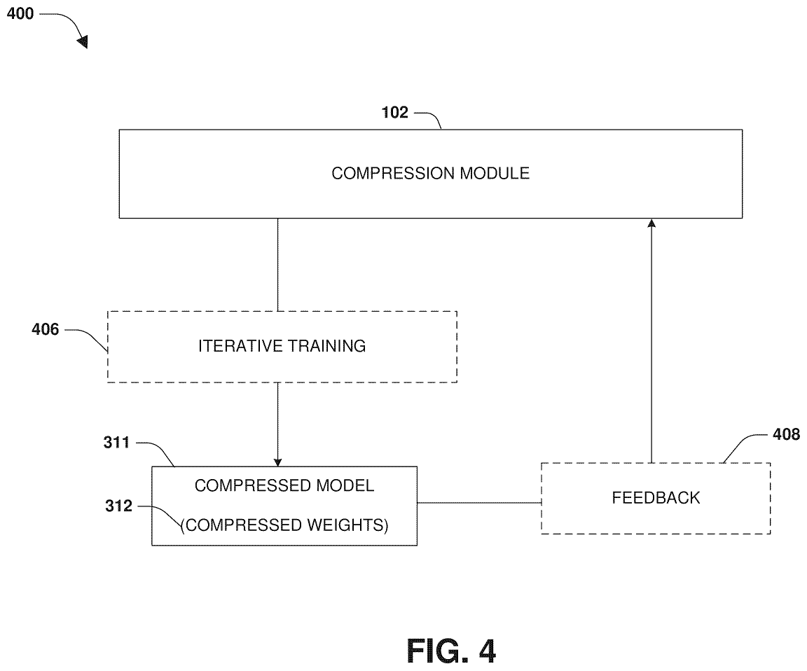

In this way, the compressed model 311 may be subsequently trained/adjusted during iterative cycles of training the compressed model 311, as illustrated by FIG. 4 where feedback 408 is used to iteratively train 406 the model 302. The weights may be compressed differently during each iteration based upon the feedback 408 corresponding to the operational statistics. In some embodiments, a plurality of difference instance of the compressed model 311 (e.g., 1,000 instances) are trained where each instance has slight variations (e.g., different weight values, parameters, compression, added noise and/or randomized errors to nudge the model away from a local minimum, etc.).

In some embodiments, a configuration of the compressed model 311 (e.g., weights, parameters, lookup tables, functions, etc.) is modified based upon resources and capabilities of the target device. The less storage, memory (e.g., a memory layout such as for an FPGA that will provide a significant improvement), compute resources of the target device, and/or architecture/capabilities of the target device, the more the compressed model 311 may be compressed so that the compressed model 311 can be run by the target device. In some embodiments, an inference engine 306 may be incorporated into a processor or FPGA of the target device. The inference engine 306 may be configured based upon characteristics of the compressed model 311. For example, the inference engine 306 is configured to skip memory accesses as part of running the compressed model 311, reduce branching performed by a branch predictor of the processor as part of running the compressed model 311, skip instructions of the compressed model 311, omit pre-compiled functions based upon functions that will not be utilized or that will be infrequently utilized during runtime, and/or omit lookup tables used to represent or store weights. The inference engine 306 may be custom tailored to only execute the compressed model 311 and is restricted from running other models so that the inference engine 306 can optimally run the compressed model 311. Once training is complete, the compressed model 311 is deployed to the target device.

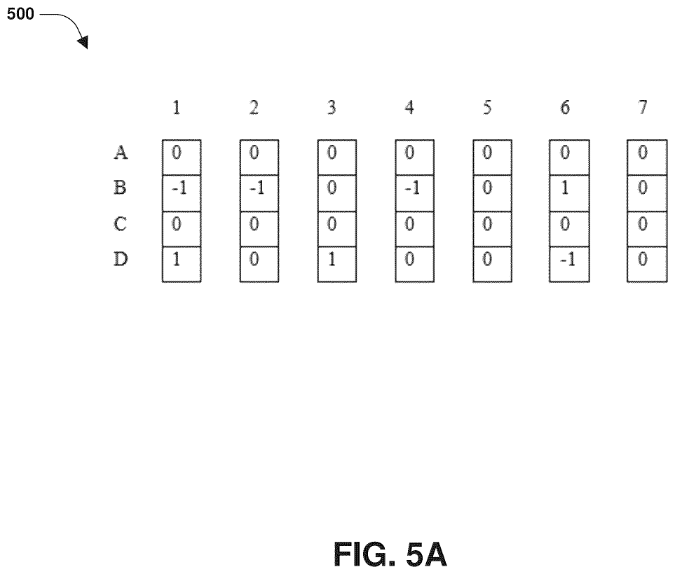

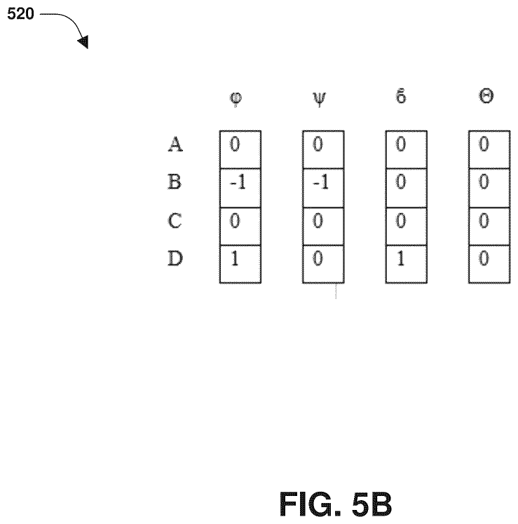

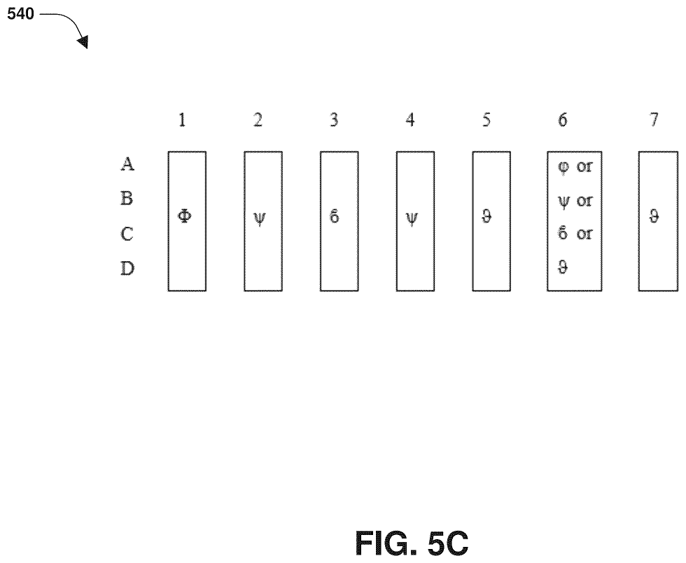

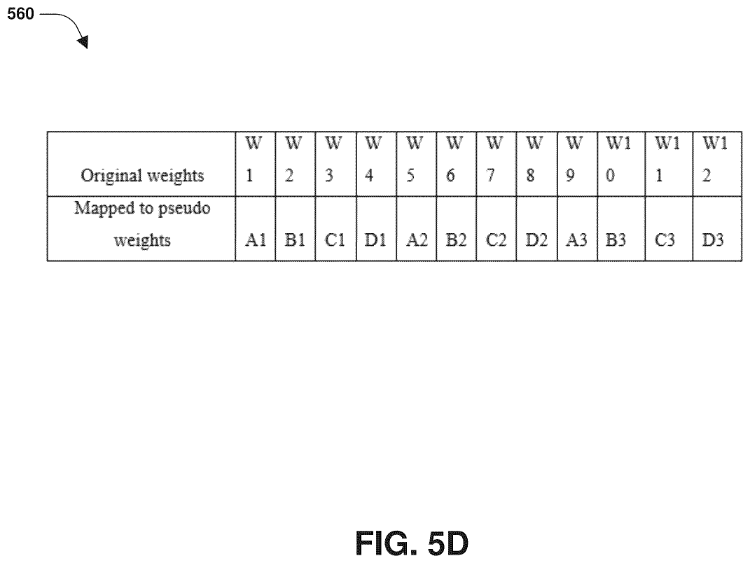

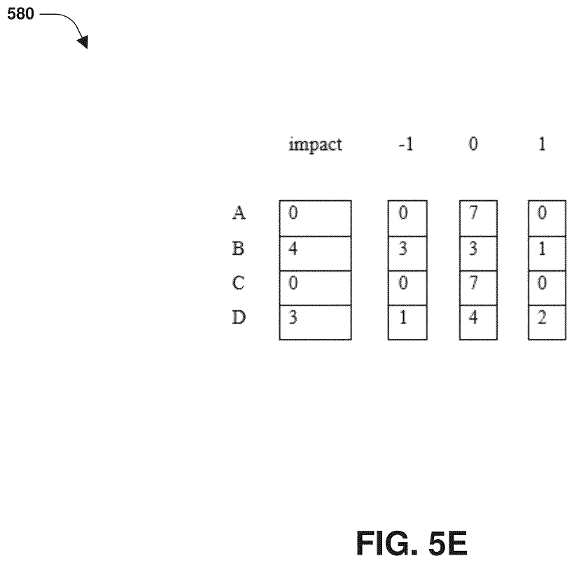

FIG. 5A-5E illustrate data structures used as part of compressing a model during training. FIG. 5A illustrates a data structure 500 where there are 4 weights A, B, C, and D that are used 7 times in the model, for example. Across the 7 instances, weight A and weight B never change and stay 0, weight B is mostly −1/0 and is 1 once, and weight D is mostly 0/1 and is −1 once. To store 4 instances of −1, 0, and 1, there will be 6.3 bits per instance. However, the 6^{th} instance of the values is replaced with values from any other instance such that weights B and D are now switching between only 2 states/values instead of 3 (e.g., weights B and D are now constrained to 2 values such as 0/1 for weight D and −1/0 for weight B), thus compressing the weights. FIG. 5B illustrates a palette 520 (a lookup table) of values so that new values can be used within data structure 540 of FIG. 5C. The palette 520 is used to constrain weight values to 4 options φ, ψ, [symbol] , and Θ (4 palette indexes with 4 matrix weights of such as 0, −1, 0, 1 for pallet index Θ), so there is 2 bits per reference (e.g., a reference that references multiple weights at once) and 0.5 bit per weight. The data structure 540 is used as a new version that references the palette 520 as a lookup to identify corresponding weight values. A few simplifications were made such as where the 6^{th} column of weights uses one of the possible 4 available values in the palette 520 (the lookup table).

In some embodiments, weights may be stored according to different rules. For example, a first rule may store certain weights using a compressed 3 value range palette such as where one global palette is used for the whole model and/or where a local palette (or a multiple local palettes) is used for portions of the model. A second rule may store certain weights as a range of 3 values (e.g., 1.5849 bits may be used to store the range of 3 values). A third rule may store weights as a compressed 5 value range palette such as where one global palette is used for the whole model and/or (or a multiple local palettes) is used for portions of the model. A fourth rule may store certain weights as a range of 5 values (e.g., 2.3221 bits may be used to store the range of 5 values). In some embodiments, the rules (a schema) may be hardcoded into the model such as after trial and error (iterative training) to see which schemas (combinations/sets of rules) product optimal results in relation to compression and quality of the model, such as through gradient descent, simulated annealing, etc.

Various approaches may be used to select which combinations of rules/compression to utilize, which may take into account metrics (e.g., feedback, operational statistics, palette usage, etc.) such as loss, error, perplexity, precision, etc. to track progress of how the model is achieving goals/targets. For example, a model may be expected to have high precision from generating coding answers, while the model does not require high precision from generating linguistic answers. Thus, various regions in the model may be compressed differently with different compression rates. In an example, a rudimentary schema rule may specify that every 2\hat{ }22 (4 194 304) weights use a new local palette to allow some variety of palettes spread out in the model. In an example, multiple different rules may be applied at the same time, such as ‘interleave palette weights with uncompressed weights 1:1’ allowing the compressed weights to shrink the size at the cost of quality, but for the uncompressed weights to compensate for and remedy the loss of quality and allow changing palettes in intervals.

In some embodiments, this approach may achieve 1-bit size while letting the training process select which pair would be beneficial from the 3 options of pairs (−1/1, −1/0, 0/1). In some embodiments, a hybrid approach may be implemented by interleaving uncompressed weights in a 1:1 ratio that would achieve 1.3219-bits compared to original 1.5849-bits (which is how much is needed to store range of 3 values). The difference of 0.263-bits per weight adds up to a significant size reduction when applied to billions of weights, while still having properties similar to an uncompressed model because the uncompressed weights can be used to fine tune and compensate for errors caused by the compressed (coarse) weights. At runtime, the weight value look-up might not affect performance much because looking up weights into a lookup table is 1 indirection call to supply multiple weights. This simple referencing into a lookup table is trivial in runtime, and improves the efficiency of running the model where the operation would otherwise be repeated billions of times.

In some embodiments, the 6^{th} row in data structure 540 is to be allocated to some value from within the palette 520 in a manner that will best align with the rest of the data and with a least amount of degradation in quality. The data structure 500 is a simplified embodiment, and in other embodiments many weights would not be 0 each time used in the model, otherwise the weights would have no impact on the outputs from the model. Additionally, patterns and repetitions might be less obvious as weights might appear more as random noise than a repeated pattern. In some embodiments, the palette 520 (lookup table) is a fraction of data, and may be tiled/repeated over existing data. This can make it difficult to identify repeated patterns and relations between weights that are completely unrelated. Different weights may be treated as different instances/iterations of a same weight. As illustrated by data structure 560 of FIG. 5D, there are 28 different weights that are treated/considered as 7 instances of 4 weights (e.g., 12 unique weights mapped to 3 instances of 4 repeated pseudo weights A, B, C, and D). Similar to the prior embodiments, W1 is now A1 and W5 is now A2, and thus A1 and A2 are pseudo weights (instance 1 and instance 2), and both can have their own value that are constrained from the palette of weight A. This binds all instances to the same set of possible values. Initially, a data structure (lookup table) starts with as many entries as there are combinations of values (the lookup references of the entries are as large as what it would take the describe the full values directly), and thus the number of entries in the data structure are reduced such as by referring to the same few entries as often as possible

In some embodiments of compressing/decimating weights is to initially start training without compression. After a predetermined period of time (e.g., 20% into the training process), compression may be considered/initiated. As part of compression, the instances of weights are traversed/evaluated in order to separately count how often each value occurs in the instances (e.g., how many instances did a weight have a weight value of −1, 0, 1, etc. For each weight value, the count of that weight value (e.g., the number of times 0 is used as a weight value) is subtracted from a total number of instances (e.g., 7 instances in this example) in order to calculate a global impact, as illustrated by data structure 580 of FIG. 5E. The data structure 580 is populated with impact values of how often each weight value was used.

The weights with the lower impact are processed first (e.g., pseudo weights A and B have the lowest impact) for compaction/compression, but since the value is 0 there is little that can be compacted. Then next smallest impact is pseudo weight D and the least used value for pseudo weight D is −1. Thus, all instances of pseudo weight D having the weight value of −1 are located and replaced within data structure 500. The weight value of −1 may be replaced with (nudged to) a closest value such as where 0 is closest to −1). After compacting/compression pseudo weight D, pseudo weight B has the next smallest impact with the least used weight value of 1, which is replaced with (nudged to) a closest value of 0. Thus, the weights in data structure 540 row 5 will reference ϑ from palette 520. In this way, the amount of possible options within the palette 520 (lookup table) are shrunk as part of compressing the weights. If a value set of weights is not used within the palette 520 (lookup table), the value set is removed from the palette 520 in order to further shrink the palette during training. If the quality of the outputs from the model 302 drop below an acceptable threshold, then the compression is stopped. In some embodiments, training with discrete values is impractical (e.g., loss functions such as gradient descent expect some gradient/valley to descend into, but the gradient would be difficult to calculate from discrete values and it would be difficult to identify which weights to adjust). Accordingly, the model may be trained with floating point numbers as weights (e.g., because a discrete jump from −1 to 0 may not help with actual training of the model such as where a gradient descent may struggle to calculate a direction towards a global/local minimum where there is no real gradient, compared to settling outside global/local minima because it could settle on a location with “fake” 0 gradient caused by the discrete steps) so the weight values may be slightly nudged to the desired value of 0 at smaller increments (e.g., 0.1 increments or any other value, such as from 1 to 0.9 as a first nudge, then 0.9 to 0.8 as a second nudge, etc.) over multiple training iterations where weights are nudged to explore other possibilities to obtain the same results/outputs.

In some embodiments of training the model, weights are initially set to random weight values, and various techniques are used to improve those weight values in order to train the model to output desired results. The weights themselves often have a self-organizing property, while the weights (weight values) are adjusted (nudged) to specific roles (“adder,” “negator,” etc.) at specific intervals. If a palette was merely 4 weights large as in the simple example discussed so far (weights A, B, C, and D), then there would be some repeat behavior such as where the second weight (pseudo weight B) and every 4^{th} weight after it (other iterations of the pseudo weight) would be nudged towards having a negative or zero weight. While for the 4^{th} weight and every 4^{th} weight thereafter may be adjusted (nudged) to encourage the opposite, zero or positive weight. Therefore the network would be encouraged to organize in such a structure, and any processing related to the D pseudo weights with −1 values would be instead encouraged through the B weights and all the positive weight values of weight B would be moved to weight D. This may restructure the model in a manner that is more compressible. If the restructuring would unduly affect quality, then the model can be interleaved with compressed weights and uncompressed weights that are unrestricted.

In some embodiments, some entries do not need to be removed from a palette in order to achieve compression benefits. Some less frequently used entries can be even further compressed. For example, if some weight is ‘nudged’ to be negator weight and has values between −1 and 0, and only very rarely has value 1, then the associated palette entry will be less frequently used, and allowing further compression for that palette entry.

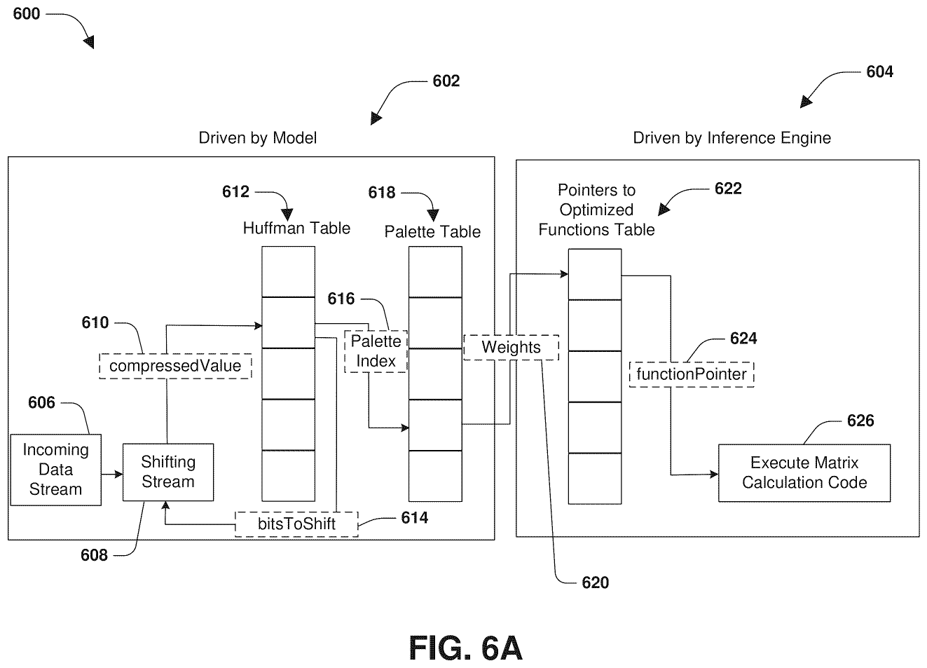

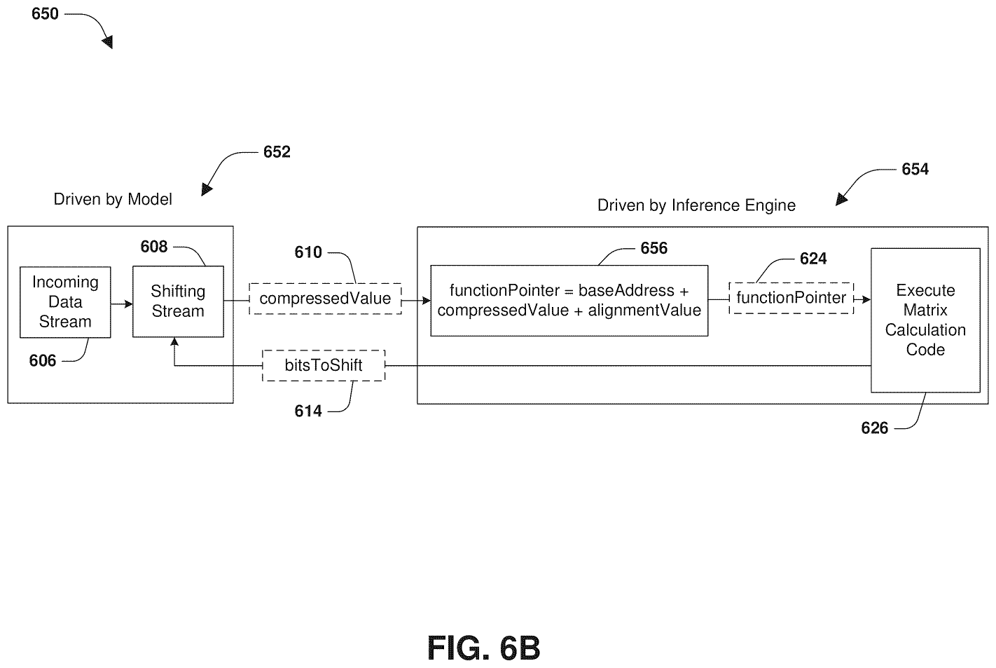

FIG. 6A is a block diagram illustrating an embodiment of a system 600 for utilizing a compressed model to generate an output. The system 600 generates the output, such as to execute matrix calculation code 626 to perform matrix multiplication, using model driven functionality 602 and inference engine functionality 604. As part of the model driven functionality 602, an incoming data stream 606 may be received, such as data upon which the model is to process to generate a result. A shifting stream 608 (e.g., bit shifting) is created based upon the incoming data stream 606. The shifting stream 608 takes bits to shift 614 as input. The bits to shift 614 are identified from a Huffman table 612 (e.g., a data structure used by a coding procedure such as Huffman coding). The shifting stream 608 outputs a compressed value 610 that is input into the Huffman table 612, which is used to identify a palette index 616 into a palette table 618 (e.g., a palette). The palette index 616 is used to identify weights represented by the palette table 618. The weights 620 are input into a table 624 (e.g., a pointers to optimized functions table) to identify a function pointer 624 associated with the weights. The function pointer 624 is used to execute the matrix calculation code 626.

The Huffman table 612 provides a desired value (the palette index 616 to a palette) and information regarding how many bits need to shift the incoming stream to obtain a next valid value (bits to shift 614). Huffman coding is variable length and does not align with 8-bit alignment, and thus the bits to shift 614 information is needed to calculate the next compressed value 610. Multiple entries in the Huffman table 612 can point to the same palette through an n:1 mapping. So, palette index Θ from data structure 520 is used to obtain matrix weights such as 0, −1, 0, and 1. This is a 1:1 mapping, and thus the matrix weights are used to locate an optimized function to call. Function pointer 624 is used to make a call and trigger the calculation by the matrix calculation code 626. In some embodiments, the function pointer 624 may be omitted and there is a function 656 embedded directly at aligned and easy to calculate locations corresponding to Huffman coding index, which is further described in relation to FIG. 6B.

FIG. 6B illustrates a system 650 for utilizing a compressed model to generate an output. The system 650 generates the output, such as to execute matrix calculation code 626 to perform matrix multiplication, using the model driven functionality 602 and the inference engine functionality 604. As part of the model driven functionality 602, an incoming data stream 606 may be received, such as data upon which the model is to process to generate a result. A shifting stream 608 (e.g., bit shifting) is created based upon the incoming data stream 606. The shifting stream 608 takes bits to shift 614 as input. The bits to shift 614 are identified from the matrix calculation code 626. The shifting stream 608 outputs a compressed value 610 that is input into a function 656 that generates a function pointer 624 associated with an implementation optimized exactly for specific weights. The function 656 identifies the function pointer based upon a base address+the compressed value 610+an alignment value. The function pointer 624 is used to execute the matrix calculation code 626. In this way, the lookup to a Huffman table 612 and/or the palette table 618 can be avoided.

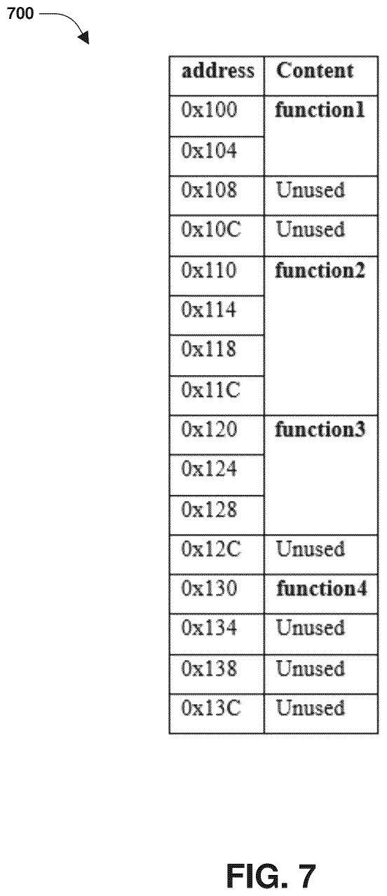

FIG. 7 is an illustration of a data structure 700 used as part of the inference engine when running the model on the target device, which allows the quick generation of a function pointer instead of performing a lookup. The data structure 700 is associated with an all-in-one approach that has 4 functions with variable sizes (e.g., with lengths of 16 bytes or less), and are padded/aligned to 16 bytes (0×10 in hex). These 4 functions can be quickly and easily called without a lookup table because the address can be trivially calculated, thus improving efficiency.

In some embodiments, a method is provided. The method includes initiating training of a model for execution on a target device; compressing, during the training, weights of the model utilizing palettes to represent weight values using bits, wherein the compressing includes adjusting a weight value of a weight that occurs less frequently than other weight values of the weight; in response to identifying an infrequently utilized palette that is less frequently repeated than other palettes, implementing a coding procedure to either remove the infrequently utilized palette or modify a bit representation for the infrequently utilized palette to be different than bit representations used for the other palettes; and deploying the model to the target device for execution.

In some embodiments, one or more weights compensate for the weight with the weight value adjusted during the training.

In some embodiments, the method comprises in response to identifying a frequently utilized palette that is more frequently repeated than the other palettes, implementing the coding procedure to utilize a different bit representation for the frequently utilized palette than the infrequently utilized palette.

In some embodiments, the method comprises in response to determining that removal of a palette entry, as part of palette shrinking performed by the coding procedure, affects quality of the model beyond an acceptable amount, modifying the weight to discourage utilization of the weight by the model.

In some embodiments, the method comprises training the model to utilize a set of compressed weights and a set of uncompressed weights for generating an inference result.

In some embodiments, the method comprises modifying, during the training, a configuration of the model based upon resources, architecture, and capabilities of the target device.

In some embodiments, the method comprises configuring an inference engine, incorporated into at least one of a processor or a field programmable gate array of the target device, based upon characteristics of the model, wherein the inference engine is configured to at least one of skip memory accesses, reduce branching performed by a branch predictor of the processor, skip instructions, omit pre-compiled functions based upon functions that will not be utilized during runtime, or omit a lookup table.

In some embodiments, the method comprises configuring an inference engine, incorporated into at least one of a processor or a field programmable gate array of the target device, based upon characteristics of the model, wherein the inference engine is restricted from running other models than the model.

In some embodiments, the method comprises configuring an inference engine based upon characteristics of the model, wherein the inference engine is restricted from running other models than the model.

In some embodiments, a computing device is provided. The computing device comprises a memory comprising machine executable code; and a coupled to the memory, the processor configured to execute the machine executable code to cause the machine to: initiate training of a model for execution on a target device; compress, during the training, weights of the model utilizing palettes to represent weight values using bits, wherein the compressing includes adjusting a weight value of a weight that occurs less frequently than other weight values of the weight; in response to identifying an infrequently utilized palette that is less frequently repeated than other palettes, implement a coding procedure to either remove the infrequently utilized palette or modify a bit representation for the infrequently utilized palette to be different than bit representations used for the other palettes; and deploy the model to the target device for execution.

In some embodiments, the machine executable code causes the machine to constrain the weight values to a set of 3 values.

In some embodiments, the machine executable code causes the machine to constrain the weight values to a set of 5 values, wherein bit shifting is implemented in place of multiplication to perform matrix multiplication.

In some embodiments, the machine executable code causes the machine to store the weights as byte-aligned data, in a case of 3 value range (1.5849-bits) a group of 5 weights is stored within a byte.

In some embodiments, the machine executable code causes the machine to introduce, during the training, randomized noise or errors to shift the model away from a local minima towards a global minima.

In some embodiments, a non-transitory machine readable medium comprising instructions for performing a method, which when executed by a machine, causes the machine to: initiate training of a model for execution on a target device; compress, during the training, weights of the model utilizing palettes to represent weight values using bits, wherein the compressing includes adjusting a weight value of a weight that occurs less frequently than other weight values of the weight; in response to identifying an infrequently utilized palette that is less frequently repeated than other palettes, implement a coding procedure to either remove the infrequently utilized palette or modify a bit representation for the infrequently utilized palette to be different than bit representations used for the other palettes; and deploy the model to the target device for execution.

In some embodiments, the instructions cause the machine to quantize and compress the weights during training, wherein new errors generated from the quantization and compression are identified; and adjust the weights during subsequent training based upon the new errors to reduce errors of the model.

In some embodiments, the instructions cause the machine to quantize the weights during training as quantizations; and utilize the quantizations to adjust the model.

In some embodiments, the instructions cause the machine to identify a first error produced by rounding the weight value to a first whole number; identify a second error produced by rounding the weight value to a second whole number; and round the weight value towards the first whole number based upon the first error being less than the second error.

In some embodiments, the instructions cause the machine to order the weights during the training to create an ordered set of weights.

In some embodiments, the instructions cause the machine to order the weights during the training to create an ordered set of weights, where a weight is swapped from a first position to a second position.

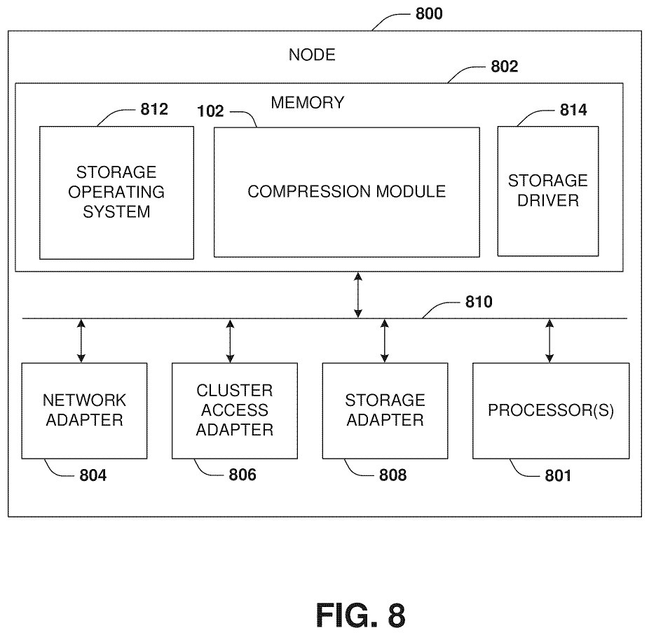

Referring to FIG. 8, a node 800 (also referred to as a storage node) in this particular example includes processor(s) 801, a memory 802, a network adapter 804, a cluster access adapter 806, and a storage adapter 808 interconnected by a system bus 810. In other examples, the node 800 comprises a virtual machine, such as a virtual storage machine.

The node 800 also includes a storage operating system 812 that can, for example, implement a RAID data loss protection and recovery scheme to optimize reconstruction of data of a failed disk or drive in an array, along with other functionality such as deduplication, snapshot creation, data mirroring, synchronous replication, asynchronous replication, encryption, etc.

The network adapter 804 in this example includes the mechanical, electrical and signaling circuitry needed to connect the node 800 to one or more of the client devices over network connections, which may comprise, among other things, a point-to-point connection or a shared medium, such as a local area network. In some examples, the network adapter 804 further communicates (e.g., using Transmission Control Protocol/Internet Protocol (TCP/IP)) via a cluster fabric and/or another network (e.g., a WAN (Wide Area Network)) (not shown) with storage devices of a distributed storage system to process storage operations associated with data stored thereon.

The storage adapter 808 cooperates with the storage operating system 812 executing on the node 800 to access information requested by one of the client devices (e.g., to access data on a data storage device managed by a network storage controller). The information may be stored on any type of attached array of writeable media such as magnetic disk drives, flash memory, and/or any other similar media adapted to store information.

In exemplary data storage devices, information can be stored in data blocks on disks. The storage adapter 808 can include I/O interface circuitry that couples to the disks over an I/O interconnect arrangement, such as a storage area network (SAN) protocol (e.g., Small Computer System Interface (SCSI), Internet SCSI (iSCSI), hyperSCSI, Fiber Channel Protocol (FCP)). The information is retrieved by the storage adapter 808 and, if necessary, processed by the processor(s) 801 (or the storage adapter 808 itself) prior to being forwarded over the system bus 810 to the network adapter 804 (and/or the cluster access adapter 806 if sending to another node computing device in the cluster) where the information is formatted into a data packet and returned to a requesting one of the client devices and/or sent to another node computing device attached via a cluster fabric. In some examples, a storage driver 814 in the memory 802 interfaces with the storage adapter to facilitate interactions with the data storage devices.

The storage operating system 812 can also manage communications for the node 800 among other devices that may be in a clustered network, such as attached to the cluster fabric. Thus, the node 800 can respond to client device requests to manage data on one of the data storage devices or storage devices of the distributed storage system in accordance with the client device requests.

A file system module of the storage operating system 812 can establish and manage one or more file systems including software code and data structures that implement a persistent hierarchical namespace of files and directories, for example. As an example, when a new data storage device (not shown) is added to a clustered network system, the file system module is informed where, in an existing directory tree, new files associated with the new data storage device are to be stored. This is often referred to as “mounting” a file system.

In the example node 800, memory 802 can include storage locations that are addressable by the processor(s) 801 and adapters 804, 806, and 808 for storing related software application code and data structures. The processor(s) 801 and adapters 804, 806, and 808 may, for example, include processing elements and/or logic circuitry configured to execute the software code and manipulate the data structures.

The storage operating system 812, portions of which are typically resident in the memory 802 and executed by the processor(s) 801, invokes storage operations in support of a file service implemented by the node 800. Other processing and memory mechanisms, including various computer readable media, may be used for storing and/or executing application instructions pertaining to the techniques described and illustrated herein.

In some embodiments, the compression module 102 is implemented by the node 800 in order to compress weights of models using the disclosed techniques described in relation to FIG. 1-7B.

The examples of the technology described and illustrated herein may be embodied as one or more non-transitory computer or machine readable media, such as the memory 802, having machine or processor-executable instructions stored thereon for one or more aspects of the present technology, which when executed by processor(s), such as processor(s) 801, cause the processor(s) to carry out the steps necessary to implement the methods of this technology, as described and illustrated with the examples herein. In some examples, the executable instructions are configured to perform one or more steps of a method described and illustrated later.

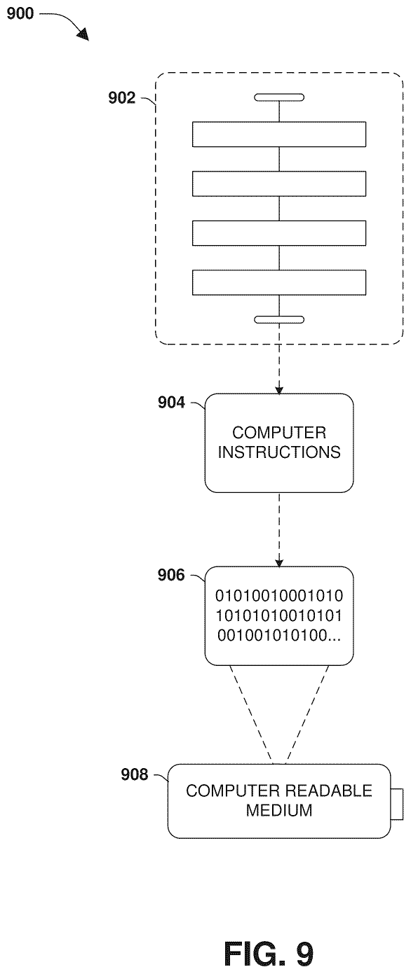

FIG. 9 is an example of a computer readable medium 900 in which various embodiments of the present technology may be implemented. An example embodiment of a computer-readable medium or a computer-readable device that is devised in these ways is illustrated in FIG. 9, wherein the implementation comprises a computer-readable medium 908, such as a compact disc-recordable (CD-R), a digital versatile disc-recordable (DVD-R), flash drive, a platter of a hard disk drive, etc., on which is encoded computer-readable data 906. The computer-readable data 906, such as binary data comprising at least one of a zero or a one, in turn comprises processor-executable computer instructions 904 configured to operate according to one or more of the principles set forth herein. In some embodiments, the processor-executable computer instructions 904 are configured to perform at least some of the exemplary methods 902 disclosed herein, such as method 200 of FIG. 2, for example. In some embodiments, the processor-executable computer instructions 904 are configured to implement a system, such as at least some of the exemplary systems disclosed herein, such as system 100 of FIG. 1, system 300 of FIG. 3, and/or system 400 of FIG. 4, for example. Many such computer-readable media are contemplated to operate in accordance with the techniques presented herein.

In some embodiments, the described methods and/or their equivalents may be implemented with computer executable instructions. Thus, in some embodiments, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on. In some embodiments, a computing device is implemented with one or more executable algorithms that are configured to perform any of the disclosed methods.

It will be appreciated that processes, architectures and/or procedures described herein can be implemented in hardware, firmware and/or software. It will also be appreciated that the provisions set forth herein may apply to any type of special-purpose computer (e.g., file host, storage server and/or storage serving appliance) and/or general-purpose computer, including a standalone computer or portion thereof, embodied as or including a storage system. Moreover, the teachings herein can be configured to a variety of storage system architectures including, but not limited to, a network-attached storage environment and/or a storage area network and disk assembly directly attached to a client or host computer. Storage system should therefore be taken broadly to include such arrangements in addition to any subsystems configured to perform a storage function and associated with other equipment or systems.

In some embodiments, methods described and/or illustrated in this disclosure may be realized in whole or in part on computer-readable media. Computer readable media can include processor-executable instructions configured to implement one or more of the methods presented herein, and may include any mechanism for storing this data that can be thereafter read by a computer system. Examples of computer readable media include (hard) drives (e.g., accessible via network attached storage (NAS)), Storage Area Networks (SAN), volatile and non-volatile memory, such as read-only memory (ROM), random-access memory (RAM), electrically erasable programmable read-only memory (EEPROM) and/or flash memory, compact disk read only memory (CD-ROM)s, CD-Rs, compact disk re-writeable (CD-RW)s, DVDs, magnetic tape, optical or non-optical data storage devices and/or any other medium which can be used to store data.

Some examples of the claimed subject matter have been described with reference to the drawings, where like reference numerals are generally used to refer to like elements throughout. In the description, for purposes of explanation, numerous specific details are set forth in order to provide an understanding of the claimed subject matter. It may be evident, however, that the claimed subject matter may be practiced without these specific details. Nothing in this detailed description is admitted as prior art.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments are provided herein. The order in which some or all of the operations are described should not be construed to imply that these operations are necessarily order dependent. Alternative ordering will be appreciated given the benefit of this description. Further, it will be understood that not all operations are necessarily present in each embodiment provided herein. Also, it will be understood that not all operations are necessary in some embodiments.

Furthermore, the claimed subject matter is implemented as a method, apparatus, or article of manufacture using standard application or engineering techniques to produce software, firmware, hardware, or any combination thereof to control a computer to implement the disclosed subject matter. The term “article of manufacture” as used herein is intended to encompass a computer application accessible from any computer-readable device, carrier, or media. Of course, many modifications may be made to this configuration without departing from the scope or spirit of the claimed subject matter.

As used in this application, the terms “component”, “module,” “system”, “interface”, and the like are generally intended to refer to a computer-related entity, either hardware, a combination of hardware and software, software, or software in execution. For example, a component includes a process running on a processor, a processor, an object, an executable, a thread of execution, an application, or a computer. By way of illustration, both an application running on a controller and the controller can be a component. One or more components residing within a process or thread of execution and a component may be localized on one computer or distributed between two or more computers.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, or variants thereof are used, such terms are intended to be inclusive in a manner similar to the term “comprising”.

Many modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first set of information and a second set of information generally correspond to set of information A and set of information B or two different or two identical sets of information or the same set of information.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
initiating training of a model for execution on a target device;
compressing, during the training, weights of the model utilizing palettes to represent weight values using bits, wherein the compressing includes adjusting a weight value of a weight that occurs less frequently than other weight values of the weight;
in response to identifying an infrequently utilized palette that is less frequently repeated than other palettes, implementing a coding procedure to either remove the infrequently utilized palette or modify a bit representation for the infrequently utilized palette to be different than bit representations used for the other palettes; and
deploying the model to the target device for execution.

2. The method of claim 1, wherein one or more weights compensate for the weight with the weight value adjusted during the training.

3. The method of claim 1, comprising:
in response to identifying a frequently utilized palette that is more frequently repeated than the other palettes, implementing the coding procedure to utilize a different bit representation for the frequently utilized palette than the infrequently utilized palette.

4. The method of claim 1, comprising:
in response to determining that removal of a palette entry, as part of palette shrinking performed by the coding procedure, affects quality of the model, modifying the weight to discourage utilization of the weight by the model.

5. The method of claim 1, comprising:
training the model to utilize a set of compressed weights and a set of uncompressed weights for generating an inference result.

6. The method of claim 1, comprising:
modifying, during the training, a configuration of the model based upon resources, architecture, and capabilities of the target device.

7. The method of claim 1, comprising:
configuring an inference engine, incorporated into the target device, based upon characteristics of the model, wherein the inference engine is configured to at least one of: skip memory accesses, reduce branching performed and increase branching predictions by a branch predictor of the processor, skip instructions, omit pre-compiled functions based upon functions that will not be utilized during runtime, or omit a lookup table.

8. The method of claim 1, comprising:
configuring an inference engine, incorporated into at least one of a processor or a field programmable gate array of the target device, based upon characteristics of the model, wherein the inference engine is restricted from running other models than the model.

9. The method of claim 1, comprising:
configuring an inference engine based upon characteristics of the model, wherein the inference engine is restricted from running other models than the model.

10. A computing device, comprising:
a memory comprising machine executable code; and
a processor coupled to the memory, the processor configured to execute the machine executable code to cause the machine to:
initiate training of a model for execution on a target device;
compress, during the training, weights of the model utilizing palettes to represent weight values using bits, wherein the compressing includes adjusting a weight value of a weight that occurs less frequently than other weight values of the weight;
in response to identifying an infrequently utilized palette that is less frequently repeated than other palettes, implement a coding procedure to either remove the infrequently utilized palette or modify a bit representation for the infrequently utilized palette to be different than bit representations used for the other palettes; and
deploy the model to the target device for execution.

11. The computing device of claim 10, wherein the machine executable code causes the machine to:
constrain the weight values to a set of 3 values.

12. The computing device of claim 10, wherein the machine executable code causes the machine to:
constrain the weight values to a set of 5 values, wherein bit shifting is implemented in place of multiplication to perform matrix multiplication.

13. The computing device of claim 10, wherein the machine executable code causes the machine to:
store the weights as byte-aligned data, wherein 5 weights are stored within a byte.

14. The computing device of claim 10, wherein the machine executable code causes the machine to:
identifying errors produced by rounding a plurality of weight values to whole numbers; and
training the model utilizing a subset of the plurality of weight values that produce a smallest error.

15. A non-transitory machine readable medium comprising instructions for performing a method, which when executed by a machine, causes the machine to:
initiate training of a model for execution on a target device;
compress, during the training, weights of the model utilizing palettes to represent weight values using bits, wherein the compressing includes adjusting a weight value of a weight that occurs less frequently than other weight values of the weight;
in response to identifying an infrequently utilized palette that is less frequently repeated than other palettes, implement a coding procedure to either remove the infrequently utilized palette or modify a bit representation for the infrequently utilized palette to be different than bit representations used for the other palettes; and
deploy the model to the target device for execution.

16. The non-transitory machine readable medium of claim 15, wherein the instructions cause the machine to:
quantize and compress the weights during training, wherein new errors generated from the quantization and compression are identified; and
adjust the weights during subsequent training based upon the new errors to reduce errors of the model.

17. The non-transitory machine readable medium of claim 15, wherein the instructions cause the machine to:
quantize the weights during training as quantizations; and
utilize the quantizations to adjust the model.

18. The non-transitory machine readable medium of claim 15, wherein the instructions cause the machine to:
identify a first error produced by rounding the weight value to a first whole number;
identify a second error produced by rounding the weight value to a second whole number; and
round the weight value towards the first whole number based upon the first error being less than the second error.

19. The non-transitory machine readable medium of claim 15, wherein the instructions cause the machine to:
order the weights during the training to create an ordered set of weights.

20. The non-transitory machine readable medium of claim 15, wherein the instructions cause the machine to:
order the weights during the training to create an ordered set of weights, where a weight is swapped from a first position to a second position.
